(19) United States
(12) Patent Application Publication
(10) Pub. No.: US 2004/0088269 A1
(43) Pub. Date: May 6, 2004

(54) Capacitance sensing to estimate weight ranges for items being transferred by a conveyor system

(76) Inventor: Susan M.F. Davis, Nampa, ID (US)

Correspondence Address: HEWLETT-PACKARD COMPANY, Intellectual Property Administration, P.O. Box 272400, Fort Collins, CO, 80527-2400, US

(21) Appl. No.: 10/286,640

(22) Filed: Oct. 31, 2002

(51) Int. Cl. G06F 17/00

(52) U.S. Cl. 705/407; 705/401

(57) ABSTRACT

A weight range estimation system is disclosed for items being transferred by a conveyor system. The weight range estimation system comprises a capacitance sensor and a processing system. The capacitance sensor is configured to sense capacitances of the items being transferred by the conveyor system and transfer capacitance indicators representing the capacitances. The processing system is configured to process the capacitance indicators to estimate weight ranges for the items. In some examples, the processing system is configured to process the weight ranges to select postage for the items, and a postage system applies the appropriate postage to the items.

### BACKGROUND OF THE INVENTION

1. Field of the Invention

The invention is related to the field of capacitance sensing, and in particular, to sensing the capacitances of items transferred by a conveyor system and processing the capacitances to estimate weight ranges for the items.

2. Statement of the Problem

Conveyors are often used to transfer items through a processing line. Sometimes it is important to estimate the weights of the items being transferred by the conveyor system. For example, mail piece processing systems use a conveyor to transfer mail pieces through a processing line. In the processing line, the items are weighed, the weights are correlated with postal rates, and the corresponding postage is applied to the items. Unfortunately, the conveyor is repeatedly paused so an in-line scale can weigh each item. These repeated pauses slow down the processing line and add wear to the conveyor components.

Capacitive sensors are used in some conveyor systems to control processing. A capacitive sensor generates an electrical field across the conveyor and senses the capacitance of items on the conveyor as they pass through the electrical field. Since the dielectric of these items is different than air, the capacitive sensor detects the presence of the items in the electrical field based on a detected change in capacitance compared to the base reading. Thus, the capacitive sensor can detect the presence of items on the conveyor. The capacitive sensor can control fill levels for an item by sensing when a material reaches the desired fill point. The capacitive sensor can also monitor the thickness or density of the items. For example, a capacitive sensor can detect flaws in plastic or paper sheets by detecting discontinuities in the thickness of the sheets.

There is a desire to improve the efficiency of conveyor systems that are paused to weigh items. In particular, there is a need to improve the efficiency of mail piece processing systems that are repeatedly paused to weigh each individual mail piece.

### SUMMARY OF THE SOLUTION

This invention helps solve the above problems with systems, methods, and software to estimate the weight ranges of items being transferred by a conveyor. Capacitive sensors are used to sense the capacitances of the items, and the capacitances are used to estimate the weight ranges. Advantageously, the conveyor does not need to be repeatedly stopped to weigh each item because the capacitive sensors can operate as the conveyor continues to move.

An example of the invention includes a weight range estimation system for items being transferred by a conveyor system. The weight range estimation system comprises a capacitance sensor and a processing system. The capacitance sensor is configured to sense capacitances of the items being transferred by the conveyor system and transfer capacitance indicators representing the capacitances. The processing system is configured to process the capacitance indicators to estimate weight ranges for the items. In some of these examples, the processing system is configured to process the weight ranges to select postage for the items.

An example of the invention includes methods of estimating weight ranges for items being transferred by a conveyor system. The methods comprise: sensing capacitances of the items being transferred by the conveyor system; generating capacitance indicators representing the capacitances; and processing the capacitance indicators to estimate the weight ranges for the items. In some of these examples, the methods further comprise processing the weight ranges to select postage for the items, and applying the postage to the items being transferred by the conveyor system.

An example of the invention includes software products for a processing system where a capacitive sensor senses capacitances of mail pieces being transferred by a conveyor system and transfers capacitance indicators representing the capacitances. The software product comprises application software and a storage system that stores the application software. The application software is configured to direct the processing system to process the capacitance indicators to select postage for the mail pieces. In some of these examples, the application software is configured to direct the processing system to maintain a data structure that correlates capacitance indicator ranges with weight ranges and that in turn correlate the weight ranges with appropriate, current postage rates.

### DESCRIPTION OF THE DRAWINGS

The same reference number represents the same element on all drawings.

FIG. 1 illustrates a weight estimation system in an example of the invention.

FIG. 2 illustrates a mail piece processing system in an example of the invention.

FIG. 3 illustrates a processing system for a mail piece processing system in an example of the invention.

### DETAILED DESCRIPTION OF THE INVENTION

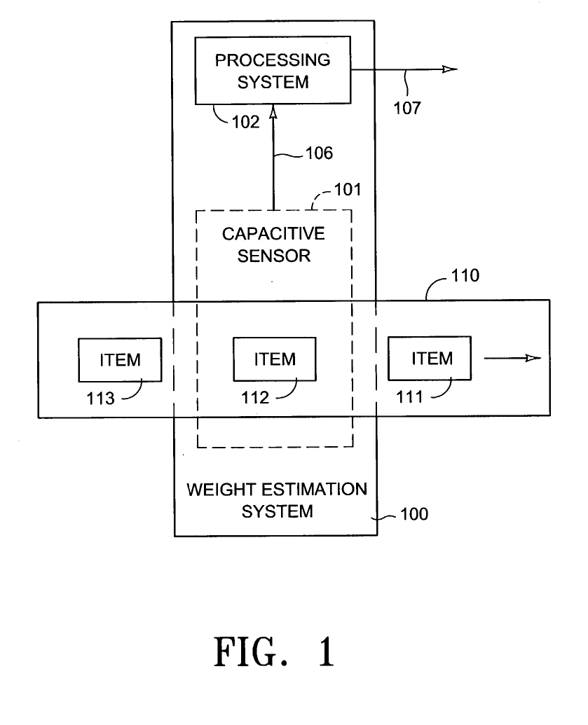

FIGS. 1-3 and the following description depict specific examples to teach those skilled in the art how to make and use the best mode of the invention. For the purpose of teaching inventive principles, some conventional aspects have been simplified or omitted. Those skilled in the art will appreciate variations from these examples that fall within the scope of the invention. Those skilled in the art will appreciate that the features described below can be combined in various ways to form multiple variations of the invention. As a result, the invention is not limited to the specific examples described below, but only by the claims and their equivalents.

Weight Range Estimation System—FIG. 1

FIG. 1 illustrates weight range estimation system 100 in an example of the invention. Weight range estimation system 100 includes capacitive sensor 101 and processing system 102. Conveyor system 110 transfers items 111-113 in series, and conveyor system 110 could be any mechanism for transferring items 111-113 through a processing line. Many more than three items are typically processed, but the number is restricted for clarity. Capacitive sensor 101 generates an appropriate electrical field across conveyor system 110. Conveyor system 110 transfers items 111-113 through this electrical field.

Capacitive sensor 101 senses the individual capacitances of items 111-113 as conveyor system 110 transfers them through the electrical field. Capacitive sensor 101 transfers capacitance indicators 106 for each of items 111-113. Capacitive indicators 106 could be digital values, corresponding voltages, or any other signal that indicates or corresponds to the capacitances of items 111-113. Capacitance indicators 106 may indicate the capacitive differences between items 111-113 and the air gaps between them. Based on this disclosure, those skilled in the art will appreciate how to modify existing capacitance sensors to appropriately install and operate capacitance sensor 101.

Processing system 102 receives and processes capacitance indicators 106 to estimate weight ranges for items 111-113. Processing system 102 transfers signal 107 indicating the weight ranges for items 111-113. Processing system 102 could also be configured based upon empirical testing that determines the correlation between capacitance indicators 106 and weight ranges for a given type of item. For example, assume items 111-113 each represent an envelope. The envelopes (as well as their respective contents) may be constructed of a wide variety of materials (e.g., paper, glue, plastic, etc). Assume also that a correlation has been established between the capacitance indicators 106 and the actual weight ranges of the envelopes. This correlation may have been previously established, for example, by performing empirical tests utilizing test envelopes. It should be noted that precise capacitance and weight determination are typically not be required. An acceptable level of precision is typically the accuracy required to allocate items 111-113 into a simple set of weight ranges. Those skilled in the art will appreciate how to modify existing processing systems to generate output from the system 102 as desired.

Items 111-113 typically have air gaps between them. Capacitance indicators 106 for the air gaps will differ from capacitance indicators 106 for items 111-113. Thus, processing system 102 can process capacitance indicators 106 to determine when an item enters and exits the electrical field. Processing system 102 may use these times along with the speed of conveyor system 110 to determine the lengths of items 111-113. Using the empirical testing technique described above, processing system 102 can be configured to estimate the weight ranges based on the lengths of items 111-113, or configured to use the lengths as an additional factor in the correlation. In addition to length, processing system 102 could be configured to estimate the weight ranges based on a width of conveyor system 110, since this width indicates a width range for items 111-113.

Processing system 102 may also process capacitance indicators 106 to indicate if any of items 111-113 have anomalous results. These items can then be removed, perhaps automatically, and handled in an alternate manner. For example, item 112 may be sufficiently different than the items used in empirical testing to configure processing system 102. If capacitance indicators 106 are received that do not fit the empirical ranges, then processing system 102 could generate a signal identifying that item 112 has anomalous results. There could be mistakes, including wrong envelope, wrong content, additional content, or missing content, and wrong media. Processing system 102 may also detect an inconsistency between the calculated length and the estimated weight range, and in response, generate a signal identifying that item 112 has anomalous results. The sophistication of the processing system 102 would determine the options for processing item 112.

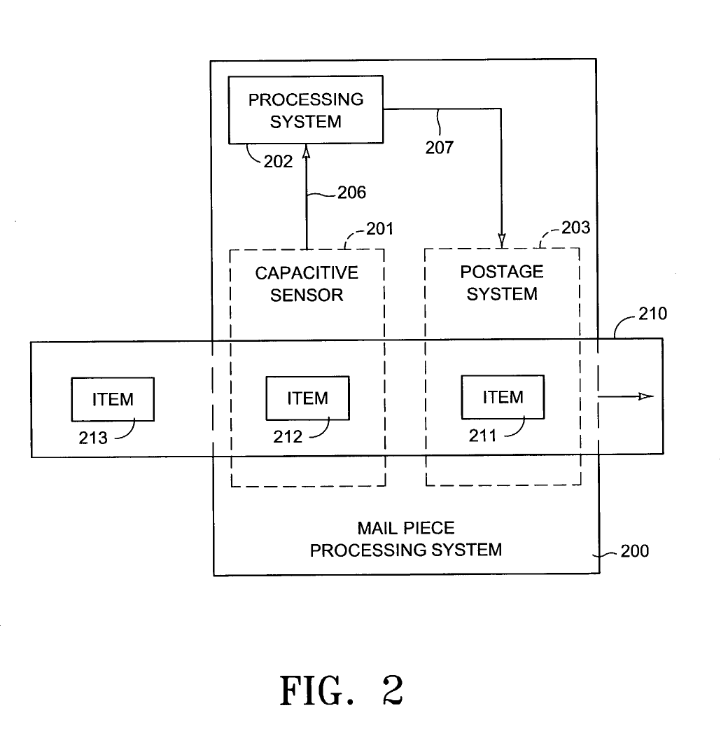

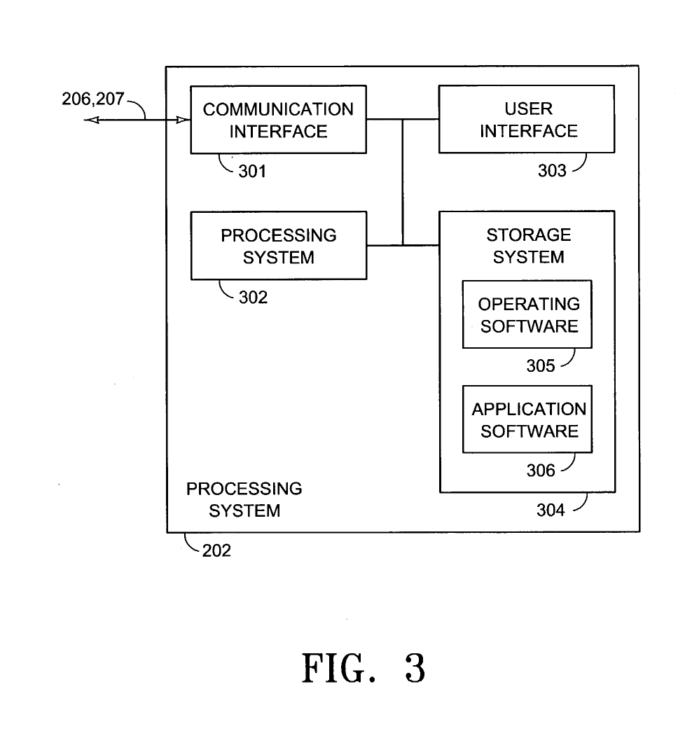

Mail Piece Processing System—FIGS. 2-3

FIG. 2 illustrates mail piece processing system 200 in an example of the invention. Mail piece processing system 200 could use the configurations and operations described above for weight estimation system 100. Mail piece processing system 200 includes capacitive sensor 201, processing system 202, and postage system 203. Capacitive sensor 201, processing system 202, and postage system 203 could be distributed among multiple devices or integrated together. Based on this disclosure, those skilled in the art will appreciate how to modify existing mail piece handling machines and capacitance sensors to make mail piece processing system 200.

In the context of the invention, the term “mail piece” means an item that is to be delivered by the United States Postal Service, or a similar delivery service such as FedEx. Typically, such deliver services charge for the use of their services. For example, the U.S. Postal service typically requires sufficient postage to be applied to a mail piece. The postage is typically some printed indicia or stamp physically placed on the mail piece to indicate a monetary amount, a class of service, or both. Mail pieces vary in weight and fall into various weight ranges, and each weight range has a corresponding postage. Advantageously, conveyor system 210 is not repeatedly paused to weigh items 211-213, so the speed of mail piece processing system 200 is appreciably improved.

Conveyor system 210 transfers mail pieces 211-213 in series. Capacitive sensor 201 generates an electrical field across conveyor system 210 so mail pieces 211-213 pass through the electrical field when they are transferred by conveyor system 210. Capacitive sensor 201 senses capacitances for mail pieces 211-213 as they pass through this electrical field. Capacitive sensor 201 transfers capacitive indicators 206 representing the approximate capacitances. Great accuracy and detailed precision are not required for mail piece processing—only enough accuracy to associate items 211-213 with their proper weight range.

Processing system 202 receives capacitive indicators 206. Processing system 202 processes capacitive indicators 206 to select appropriate postage for mail pieces 211-213. The processing may entail processing capacitance indicators 206 to estimate weight ranges for mail pieces 211-213, and then further processing the weight ranges to select the postage. Processing system 202 transfers signal 207 indicating the postage to postage system 203. In response to postage signal 207, postage system 203 applies the postage to mail pieces 211, 212, and 213 as they are transferred by conveyor system 210.

The empirical testing technique discussed above could be used to configure mail piece processing system 200. The test items could be a particular type of mail, such as paper envelopes that typically have paper contents. During testing, test envelopes of various weights could be used to build a correlation between capacitance and the weight ranges offered by the delivery service. The dielectric of paper may also be used in building a correlation between the capacitance of envelopes and the postal weight ranges.

FIG. 3 illustrates processing system 202 in an example of the invention. Processing system 202 includes communication interface 301, processing system 302, user interface 303, and storage system 304. Storage system 304 stores operating software 305 and application software 306. Processing system 302 is linked to communication interface 301, user interface 303, and storage system 304. Processing system 202 could be comprised of a programmed general-purpose computer, although those skilled in the art will appreciate that programmable or special purpose circuitry and equipment may be used. Processing system 202 may use a client server architecture where operations are distributed among a server system and client devices that together comprises elements 301-306.

Communication interface 301 could comprise a network interface card, modem, port, or some other communication device. Communication interface 301 may be distributed among multiple communication devices. Processing system 302 could comprise a computer microprocessor, logic circuit, or some other processing device. Processing system 302 may be distributed among multiple processing devices. User interface 303 could comprise a keyboard, mouse, voice recognition interface, microphone and speakers, graphical display, touch screen, or some other type of user device. Storage system 304 could comprise a disk, tape, integrated circuit, server, or some other memory device. Storage system 304 may be distributed among multiple memory devices.

Processing system 302 receives capacitance indicators 206 and transfers postage signal 207 through communication interface 301. Processing system 302 retrieves and executes operating software 305 and application software 306 from storage system 304. Operating software 305 may comprise an operating system, utilities, drivers, networking software, and other software typically loaded onto a general-purpose computer. Application software 306 could comprise an application program, firmware, or some other form of machine-readable processing instructions. When executed by processing system 302, application software 306 directs processing system 302 to operate as described above for processing system 202.

Application software 306 could direct processing system 302 to maintain a data structure that correlates capacitance indicator ranges with weight ranges and that correlates weight ranges with postage or service rates. Processing system 302 would enter the capacitance ranges with capacitance indicators 206 and matriculate through the weight ranges to yield the appropriate postage. The data structure could be updated as postage or service rates change. The data structure could be updated based on periodic re-calibration testing or changes to the weight ranges.

What is claimed is:

1. A method of estimating weight ranges for items being transferred by a conveyor system, the method comprising:
sensing capacitances of the items being transferred by the conveyor system;
generating capacitance indicators representing the capacitances; and
processing the capacitance indicators to estimate the weight ranges for the items.

2. The method of claim 1 further comprising processing the weight ranges to select a delivery charge for the items.

3. The method of claim 1 further comprising processing the weight ranges to select a postage for the items; and applying the postage to the items being transferred by the conveyor system.

4. The method of claim 2 further comprising maintaining a data structure that correlates capacitance indicator ranges with the weight ranges and that correlates the weight ranges with the delivery charge.

5. The method of claim 1 wherein processing the capacitance indicators to estimate the weight ranges for the items comprises utilizing a pre-determined correlation between the capacitance indicators and the weight ranges.

6. The method of claim 1 wherein processing the capacitance indicators to estimate the weight ranges for the items comprises processing the capacitance indicators to determine lengths of the items and estimating the weight ranges based on the lengths of the items.

7. The method of claim 1 wherein processing the capacitance indicators to estimate the weight ranges for the items comprises estimating the weight ranges based on a width of the conveyor system.

8. The method of claim 1 further comprising processing the capacitance indicators to indicate ones of the items with anomalous results.

9. A weight range estimation system for items being transferred by a conveyor system, the weight range estimation system comprising:
a capacitance sensor configured to sense capacitances of the items being transferred by the conveyor system and transfer capacitance indicators representing the capacitances; and
a processing system configured to process the capacitance indicators to estimate weight ranges for the items.

10. The weight range estimation system of claim 9 wherein the processing system is configured to process the weight ranges to select postage for the items.

11. The weight range estimation system of claim 10 further comprising a postage system configured to apply the postage to the items being transferred by the conveyor system.

12. The weight range estimation system of claim 10 wherein the processing system is configured to maintain a data structure that correlates capacitance indicator ranges with the weight ranges and that correlates the weight ranges with postage rates.

13. The weight range estimation system of claim 9 wherein the processing system is configured to correlate the capacitance indicators to the weight ranges based on a pre-determined relationship.

14. The weight range estimation system of claim 9 wherein the processing system is configured to process the capacitance indicators to determine lengths of the items and to estimate the weight ranges based on the lengths of the items.

15. The weight range estimation system of claim 9 wherein the processing system is configured to estimate the weight ranges based on a width of the conveyor system.

16. The weight range estimation system of claim 9 wherein the processing system is configured to process the capacitance indicators to indicate ones of the items with anomalous results.

17. A software product for a processing system wherein a capacitive sensor senses capacitances of mail pieces being transferred by a conveyor system and transfers capacitance indicators representing the capacitances, the software product comprising:
application software configured to direct the processing system to process the capacitance indicators to select postage for the mail pieces; and
a storage system that stores the application software.

18. The software product of claim 17 wherein the application software is configured to direct the processing system to maintain a data structure that correlates capacitance indicator ranges with weight ranges and that correlates the weight ranges with postage rates.

19. The software product of claim 17 wherein the application software is configured to direct the processing system to process the capacitance indicators to determine lengths of the items and to estimate weight ranges for the items based on the lengths of the items.

20. The software product of claim 17 wherein the application software is configured to direct the processing system to process the capacitance indicators to indicate mail pieces with anomalous results.
